(19) United States
(12) Patent Application Publication
(10) Pub. No.: US 2025/0093552 A1
(43) Pub. Date: Mar. 20, 2025

(54) ANTIGLARE LAYER-EQUIPPED TRANSPARENT SUBSTRATE, PRODUCTION METHOD FOR ANTIGLARE LAYER-EQUIPPED TRANSPARENT SUBSTRATE, AND IMAGE DISPLAY DEVICE

(71) Applicant: AGC Inc., Tokyo (JP)

(72) Inventors: Yasuhisa NISHIKAWA, Tokyo (JP); Kazuya Takemoto, Tokyo (JP); Hideaki Takahoshi, Tokyo (JP); Tamotsu Morimoto, Tokyo (JP)

(73) Assignee: AGC Inc., Tokyo (JP)

(21) Appl. No.: 18/962,964

(22) Filed: Nov. 27, 2024

Related U.S. Application Data
(63) Continuation of application No. PCT/JP2023/019735, filed on May 26, 2023.

(30) Foreign Application Priority Data
May 31, 2022 (JP) 2022-089066

(51) Int. Cl. G02B 1/118; G02B 1/115; G02B 1/18

(52) U.S. Cl. CPC G02B 1/118; G02B 1/115; G02B 1/18

(57) ABSTRACT

An antiglare layer-attached transparent substrate includes: a transparent substrate comprising two main surfaces; and an antiglare layer and an anti-reflective layer in this order on at least one main surface of the transparent substrate. The antiglare layer-attached transparent substrate has a haze value of 30% or more, and a skewness Ssk of 0.4 or less on a surface having the antiglare layer, and the antiglare layer contains fine particles, and a difference between a thickness of the antiglare layer and an average particle diameter of the fine particles is 4 μm or less.

### CROSS-REFERENCE TO RELATED APPLICATIONS

This is a bypass continuation of International Application No. PCT/2023/019735 filed on May 26, 2023, and claims priority from Japanese Patent Application No. 2022-089066 filed on May 31, 2022, the entire content of which is incorporated herein by reference.

### TECHNICAL FIELD

The present invention relates to an antiglare layer-attached transparent substrate, a method for producing an antiglare layer-attached transparent substrate, and an image display device.

### BACKGROUND ART

In recent years, a method of installing a transparent substrate such as a cover glass on a front surface of an image display device such as a liquid crystal display (LCD) has been used from the viewpoint of aesthetic appearance. However, one of problems with this transparent substrate is glare caused by reflection of an external light.

In the related art, a transparent substrate provided with an antiglare layer (hereinafter also referred to as an antiglare layer-attached transparent substrate) has been known to prevent glare from an external light (see, for example, Patent Literatures 1 and 2). The antiglare layer has an irregular shape on one surface, which diffuses a specularly reflected light and increases a haze value, thereby imparting antiglare properties.

As a transparent substrate provided with an antiglare layer, Patent Literature 1 discloses a front panel for a display device including an antiglare layer formed by dispersing particles having an average diameter of 1 μm to 10 μm in a resin matrix.

In addition, Patent Literature 2 discloses an antiglare film having a surface shape in which a skewness Rsk is less than 0 and an average length RSm of roughness curve elements is 1 μm to 50 μm.

The antiglare layer-attached transparent substrate in the related art has a low haze value (for example, less than 30%), and such an antiglare layer-attached transparent substrate does not undergo cloudiness on the surface even when stains such as fingerprints adhering to the surface are removed by wiping with a cloth or the like.

### CITATION LIST

### Patent Literature

Patent Literature 1: WO 2019/017072
Patent Literature 2: JP6824939B

### SUMMARY OF INVENTION

### Technical Problem

In recent years, image display devices have become larger. In a large image display device, the problem of glare occurs more remarkably than in a small or medium image display device, and therefore an antiglare layer-attached transparent substrate having a higher haze value is required.

The inventors of the present invention have found a new problem that, in an antiglare layer-attached transparent substrate having such a high haze value (for example, 30% or more), when stains adhering to the surface are wiped with a cloth or the like, the surface undergoes cloudiness.

In addition, the inventors of the present invention have found that the surface of the antiglare layer-attached transparent substrate having a high haze value undergoes the cloudiness since fibers of the cloth get caught in an irregular shape of the antiglare layer when the surface is wiped with the cloth or the like.

On the other hand, the above Patent Literatures 1 and 2 do not pay any attention to the new problem of cloudiness in the antiglare layer-attached transparent substrate having such a high haze.

Therefore, in light of the above newly found problem, an object of the present invention is to provide an antiglare layer-attached transparent substrate which has excellent antiglare properties and which does not undergo cloudiness on a surface when the surface of the antiglare layer-attached transparent substrate is wiped with a cloth. In addition, an object of the present invention is to provide a method for producing an antiglare layer-attached transparent substrate, and an image display device including the above antiglare layer-attached transparent substrate.

### Solution to Problem

As a result of extensive investigations, the inventors of the present invention have found that the above problems can be solved by adjusting the irregular shape of the antiglare layer, and have thus completed the present invention.

That is, the present invention has the following configuration.

[1] An antiglare layer-attached transparent substrate including:
a transparent substrate having two main surfaces; and
an antiglare layer and an anti-reflective layer in this order on at least one main surface of the transparent substrate, in which
the antiglare layer-attached transparent substrate has a haze value of 30% or more, and a skewness Ssk of 0.4 or less on a surface having the antiglare layer, and
the antiglare layer contains fine particles, and a difference between a thickness of the antiglare layer and an average particle diameter of the fine particles is 4 μm or less.

[2] The antiglare layer-attached transparent substrate according to [1], in which a dynamic friction coefficient on the surface having the antiglare layer is 0.3 or less.

[3] The antiglare layer-attached transparent substrate according to [1] or [2], in which the fine particles are spherical.

[4] The antiglare layer-attached transparent substrate according to any one of [1] to [3], in which the fine particles include resin particles.

[5] The antiglare layer-attached transparent substrate according to any one of [1] to [3], in which the fine particles include silica particles.

[6] The antiglare layer-attached transparent substrate according to any one of [1] to [5], in which the anti-reflective layer has a laminated structure in which at least two dielectric layers having different refractive indices are laminated.

[7] The antiglare layer-attached transparent substrate according to [6], in which at least one layer of the dielectric layers is mainly formed of an oxide containing at least one element selected from the group consisting of Si, Nb, Ti, Zr, Ta, Al, Sn, and In, or a nitride containing at least one element selected from the group consisting of Si and Al.

[8] The antiglare layer-attached transparent substrate according to [6], in which at least one layer of the dielectric layers is mainly formed of a Si oxide, at least another layer among the layers in the laminated structure is mainly formed of a mixed oxide of an oxide containing at least one element selected from the group A consisting of Mo and W and an oxide containing at least one element selected from the group B consisting of Si, Nb, Ti, Zr, Ta, Al, Sn, and In, and a content of elements of the group B contained in the mixed oxide is 65 mass % or less with respect to a total of elements of the group A contained in the mixed oxide and the elements of the group B contained in the mixed oxide.

[9] The antiglare layer-attached transparent substrate according to any one of [1] to [8], further including an antifouling film on the anti-reflective layer.

[10] The antiglare layer-attached transparent substrate according to any one of [1] to [9], in which the transparent substrate includes a glass.

[11] The antiglare layer-attached transparent substrate according to any one of [1] to [9], in which the transparent substrate includes a resin.

[12] A method for producing the antiglare layer-attached transparent substrate according to any one of [1] to [11], including:
forming an antiglare layer on at least one surface of a transparent substrate; and
forming an anti-reflective layer on a surface of the antiglare layer by using a dry method.

[13] A method for producing the antiglare layer-attached transparent substrate according to any one of [1] to [11], including:
forming an antiglare layer on at least one surface of a transparent substrate; and
forming an anti-reflective layer on a surface of the antiglare layer by using a wet method.

[14] An image display device including the antiglare layer-attached transparent substrate according to any one of [1] to [11].

### Advantageous Effects of Invention

In the present invention, it is possible to provide an antiglare layer-attached transparent substrate which has excellent antiglare properties and which prevents cloudiness of a surface when the surface of the antiglare layer-attached transparent substrate is wiped with a cloth. Due to the above features, an antiglare layer-attached transparent substrate according to one aspect of the present invention is suitable as a cover glass of an image display device.

In addition, with the method for producing an antiglare layer-attached transparent substrate according to the present invention, it is possible to produce an antiglare layer-attached transparent substrate having the above features.

In addition, according to one aspect of the present invention, it is possible to provide an image display device including the above antiglare layer-attached transparent substrate.

### BRIEF DESCRIPTION OF DRAWINGS

FIG. 1 is a cross-sectional view schematically showing a configuration example of an antiglare layer-attached transparent substrate according to an embodiment of the present invention.

FIG. 2 is a cross-sectional view of an antiglare layer, and is a schematic diagram showing a thickness of the antiglare layer.

FIGS. 3A to 3F are laser microscope photographs showing surface shapes of antiglare layer-attached transparent substrates in Examples 1 to 6.

FIGS. 4A and 4B are laser microscope photographs showing surface shapes of antiglare layer-attached transparent substrates in Examples 7 and 8.

FIGS. 5A to 5E are laser microscope photographs showing surface shapes of antiglare layer-attached transparent substrates in Examples 9 to 13.

FIGS. 6A to 6E are laser microscope photographs showing surface shapes of antiglare layer-attached transparent substrates in Examples 14 to 18.

FIGS. 7A to 7H are scanning electron microscope photographs showing cross sections of the antiglare layer-attached transparent substrates in Examples 1 to 8.

### DESCRIPTION OF EMBODIMENTS

Hereinafter, embodiments of the present invention are described.

Note that, in the present description, “another layer, film, or the like being provided on a main surface of a substrate such as a transparent substrate, on a layer such as an antiglare layer, or on a layer such as an anti-reflective layer” is not limited to an embodiment in which the another layer, film, or the like is provided in contact with the main surface, layer, or film, but may be an embodiment in which the layer, film, or the like is provided in an upward direction. For example, “including an antiglare layer on a main surface of a transparent substrate” means that the antiglare layer is provided in contact with the main surface of the transparent substrate, or any other layer, film, or the like may be provided between the transparent substrate and the antiglare layer.

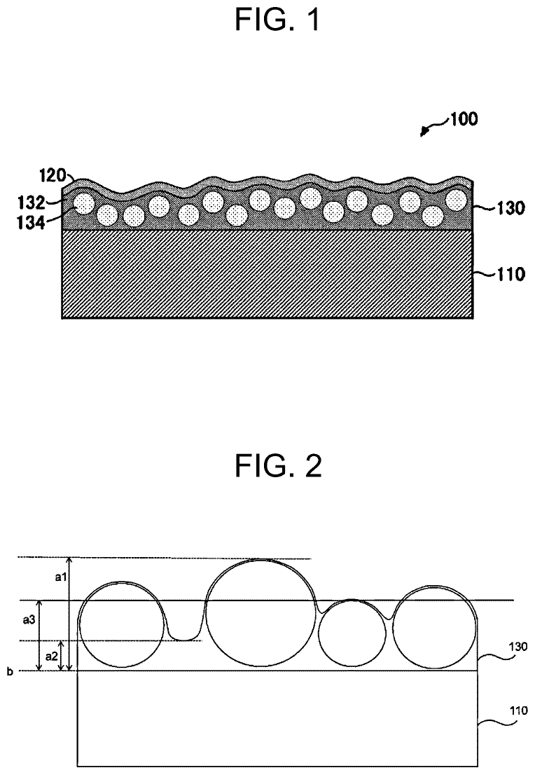

FIG. 1 is a cross-sectional view schematically showing a configuration example of an antiglare layer-attached transparent substrate according to an embodiment of the present invention. In the antiglare layer-attached transparent substrate 100 shown in FIG. 1, an antiglare layer 130 is formed on a transparent substrate 110, and an anti-reflective layer 120 is formed on the antiglare layer 130.

### <<Antiglare Layer-Attached Transparent Substrate>>

An antiglare layer-attached transparent substrate according to the present embodiment includes: a transparent substrate having two main surfaces; and an antiglare layer and an anti-reflective layer in this order on at least one main surface of the transparent substrate. The antiglare layer-attached transparent substrate has a haze value of 30% or more, and a skewness Ssk of 0.4 or less on a surface having the anti-reflective layer, and the antiglare layer contains fine particles, and a difference between a thickness of the antiglare layer and an average particle diameter of the fine particles is 4 μm or less.

### <Transparent Substrate>

The transparent substrate in the present embodiment has two main surfaces. Note that, “transparent” in the transparent substrate means that a visible light transmittance is 50% or more. The visible light transmittance is measured according to JIS Z 8709:1999.

The transparent substrate in the present embodiment preferably has a refractive index of 1.4 or more and 1.7 or less.

When the refractive index of the transparent substrate is within the above range, reflection at an adhesion surface can be sufficiently prevented in the case of optically adhering a display, a touch panel, or the like. The refractive index is more preferably 1.45 or more, still more preferably 1.47 or more, and is more preferably 1.65 or less, still more preferably 1.6 or less.

The transparent substrate in the present embodiment is not particularly limited as long as it is a “transparent” member. Examples of the transparent substrate include a glass or a resin.

In the case where the transparent substrate includes a glass, the kind of the glass is not particularly limited, and glasses having various compositions can be used. Among them, the glass preferably contains sodium and preferably has a composition that allows molding and strengthening by a chemical strengthening treatment. Specific examples thereof include an aluminosilicate glass, a soda lime glass, a borosilicate glass, a lead glass, an alkali barium glass, and an aluminoborosilicate glass.

Note that, in the present description, in the case where the transparent substrate includes a glass, the transparent substrate is also called a glass substrate.

The thickness of the glass substrate is not particularly limited, and in the case of subjecting the glass to a chemical strengthening treatment, generally, the thickness is preferably 5 mm or less, more preferably 3 mm or less, and still more preferably 1.5 mm or less, in order to effectively perform the chemical strengthening. It is generally 0.2 mm or more.

The glass substrate is preferably a chemically strengthened glass obtained by chemical strengthening. Accordingly, the strength of the antiglare layer-attached transparent substrate is increased. Note that, in the case of subjecting the glass substrate to chemical strengthening, the chemical strengthening is performed after providing an antiglare layer to be described later and before forming an anti-reflective layer.

In the case where the transparent substrate includes a resin, the kind of the resin is not particularly limited, and resins having various compositions can be used. Among them, the resin is preferably a thermoplastic resin or a thermosetting resin. Examples thereof include a polyvinyl chloride resin, a polyethylene resin, a polypropylene resin, a polystyrene resin, a polyvinyl acetate resin, a polyester resin, a polyurethane resin, a cellulose-based resin, an acrylic resin, an AS (acrylonitrile-styrene) resin, an ABS (acrylonitrile-butadiene-styrene) resin, a fluorine-based resin, a thermoplastic elastomer, a polyamide resin, a polyimide resin, a polyacetal resin, a polycarbonate resin, a modified polyphenylene ether resin, a polyethylene terephthalate resin, a polybutylene terephthalate resin, a polylactic acid-based resin, a cyclic polyolefin resin, a polyphenylene sulfide resin, and a silicone resin. Among them, a cellulose-based resin (for example, a triacetyl cellulose resin), a polycarbonate resin, and a polyethylene terephthalate resin, or the like is preferred. These resins may be used alone or in combination of two or more kinds thereof.

The resin particularly preferably includes at least one resin selected from a polyethylene terephthalate resin, a polycarbonate resin, an acrylic resin, a silicone resin, and a triacetyl cellulose resin.

Note that, in the present description, in the case where the transparent substrate includes a resin, the transparent substrate is also called a resin substrate.

The shape of the resin substrate is not particularly limited. Examples thereof include a film shape or a plate shape, and a film shape is preferred from the viewpoint of shatterproofness.

In the case where the resin substrate has a film shape, that is, when it is a resin film, the thickness is not particularly limited, and is preferably 20 μm to 250 μm, and more preferably 40 μm to 188 μm.

In the case where the resin substrate has a plate shape, that is, when it is a resin plate, the thickness is not particularly limited, and is preferably generally 5 mm or less, more preferably 3 mm or less, and still more preferably 1.5 mm or less. It is generally 0.2 mm or more.

In the case where the transparent substrate includes both a glass and a resin, for example, the resin substrate may be provided on the glass substrate.

### <Antiglare Layer>

The antiglare layer (hereinafter also referred to as AG layer) in the present embodiment is provided on at least one of the main surfaces of the above transparent substrate. The antiglare layer has an irregular shape on one surface or causes internal scattering, and thus diffuses a specularly reflected light, increases the haze value, and imparts a function of reducing dazzle or glare.

As shown in FIG. 1, the antiglare layer 130 includes a matrix 132 and fine particles 134 dispersed in the matrix. However, the antiglare layer may contain components other than the matrix and the fine particles dispersed in the matrix. Examples of the other components include a leveling agent, a silane coupling agent, an antistatic agent, an ultraviolet absorber, an antioxidant, a light- and heat-resistant stabilizer, and an antifoaming agent.

The matrix is preferably formed of a resin. As the resin, for example, polymer resins such as a polyester-based resin, an acrylic resin, an acrylic urethane-based resin, a polyester acrylate-based resin, a polyurethane-based acrylate resin, an epoxy acrylate-based resin, and a urethane-based resin can be used.

The fine particles may be in the form of spheres, cubes, plates, scales, needles, or the like. Among them, the fine particles are preferably spherical from the viewpoint of preventing the surface of the antiglare layer-attached transparent substrate from undergoing cloudiness when the surface is wiped with a cloth. Note that, in the present description, the spherical does not necessarily have to be a perfect sphere, but means having a high degree of sphericity, and more specifically, refers to an aspect ratio of 0.7 to 1. Here, the aspect ratio is a value obtained by dividing a maximum major diameter by a perpendicular diameter of the maximum major diameter of a fine particle.

The fine particles preferably include resin particles. When the fine particles include resin particles, the cloudiness caused by wiping with a cloth is further prevented. Examples of the resin particles include organic fine particles such as a styrene resin, a urethane resin, a benzoguanamine resin, a silicone resin, an acrylic resin, and the like. However, the fine particles are not limited to these and may include inorganic particles. Examples of inorganic particles include silica particles, zirconia, and glass particles. Among them, the fine particles preferably include silica particles. In addition, as the fine particles, organic-inorganic composite particles in which an organic component and an inorganic component are combined can also be used.

Note that, the antiglare layer in the present embodiment may contain two or more kinds of fine particles formed of different materials.

A ratio of the fine particles contained in the matrix is selected based on optical properties required for the antiglare layer-attached transparent substrate. In the case where it is desired to reduce the haze value of the antiglare layer-attached transparent substrate, a content of the fine particles is selected to be small, and in the case where it is desired to increase the haze value of the antiglare layer-attached transparent substrate, the content of the fine particles is selected to be large. Therefore, a weight ratio of the fine particles to the matrix (fine particles: matrix) can be changed as desired.

The inventors of the present invention have found that when the difference between the average particle diameter of the fine particles and the thickness of the antiglare layer (average particle diameter of fine particles-thickness of antiglare layer) is 4 μm or less, the cloudiness of the surface of the antiglare layer-attached transparent substrate is prevented when the surface is wiped with a cloth.

When the difference between the average particle diameter of the fine particles and the thickness of the antiglare layer is 4 μm or less, even when the surface of the antiglare layer-attached transparent substrate is wiped with a cloth, fibers of the cloth do not get caught in a fine irregular shape on the surface, so that the cloudiness is prevented.

On the other hand, when the difference between the average particle diameter of the fine particles and the thickness of the antiglare layer is more than 4 μm, the irregular shape of the surface of the obtained antiglare layer-attached transparent substrate becomes large, and when the surface is wiped with a cloth, the fibers of the cloth get caught in the fine irregular shape, and the surface of the antiglare layer-attached transparent substrate undergoes cloudiness.

The difference between the average particle diameter of the fine particles and the thickness of the antiglare layer is preferably 3 μm or less. In addition, the difference between the average particle diameter of the fine particles and the thickness of the antiglare layer is preferably −2 μm or more, more preferably 0 μm or more, and still more preferably 1 μm or more, from the viewpoint of hardness. The difference between the average particle diameter of the fine particles and the thickness of the antiglare layer is preferably-2 μm or more and 4 μm or less, for example.

In the present embodiment, in the antiglare layer, the difference between the average particle diameter of the fine particles and the thickness of the antiglare layer is preferably 4 μm or less and a ratio of the difference between the average particle diameter of the fine particles and the thickness of the antiglare layer to the thickness of the antiglare layer is preferably 0% or more and 230% or less. When the ratio is within the above range, the cloudiness of the surface of the antiglare layer-attached transparent substrate can be further prevented when the surface is wiped with a cloth. The ratio is more preferably 10% or more, and still more preferably 25% or more. In addition, the ratio is more preferably 200% or less, and still more preferably 150% or less.

In the present embodiment, the average particle diameter of the fine particles is preferably 0.1 μm or more, more preferably 1 μm or more, and still more preferably 2 μm or more, from the viewpoint of scattering properties. In addition, the average particle diameter of the fine particles is preferably 15 μm or less, more preferably 10 μm or less, and still more preferably 5 μm or less, from the viewpoint of image clarity. The average particle diameter of the fine particles is preferably 0.1 μm or more and 15 μm or less, for example. Note that, in the present embodiment, as the fine particles, two or more kinds of fine particles having different average particle diameters may be used in combination.

The average particle diameter of the fine particles in the antiglare layer-attached transparent substrate is measured from a surface image of the finally obtained antiglare layer-attached transparent substrate.

More specifically, the surface of the antiglare layer-attached transparent substrate is photographed with an optical microscope. A maximum diameter of each of 12 fine particles freely selected from the obtained surface image in any 120 μm×100 μm region is measured, and the average particle diameter is calculated by averaging the maximum diameters. In the case where the shape of the fine particles is not symmetrical, for example, in the case where the shape is elliptical or flake-like (scale-like), the maximum major diameter is used as the particle diameter to calculate the average particle diameter.

In the present embodiment, the thickness of the antiglare layer is preferably 0.5 μm or more, more preferably 1 μm or more, and still more preferably 2 μm or more, from the viewpoint of hardness. In addition, it is preferably 10 μm or less, more preferably 7 μm or less, and still more preferably 6 μm or less, from the viewpoint of warpage. The thickness of the antiglare layer is preferably 0.5 μm or more and 10 μm or less, for example.

The thickness of the antiglare layer can be obtained by taking, with a scanning electron microscope, a photograph of a cross section of the antiglare layer-attached transparent substrate. Specifically, a cross-sectional image of the antiglare layer is obtained by photographing the antiglare layer with a scanning electron microscope, as shown in FIG. 2. When a distance from a bottom surface (b) on a transparent substrate side to the highest position is defined as a maximum height (a1) and a distance from the bottom surface (b) to a lowest position is defined as a minimum height (a2) in the antiglare layer, the thickness of the antiglare layer is obtained by calculating a median value (a3=(a1+a2)/2) between the maximum height (a1) and the minimum height (a2).

More specifically, photographs of cross sections of the antiglare layer-attached transparent substrate at any five locations, each having 15 μm×20 μm, are taken with a scanning electron microscope. Next, the minimum height and the maximum height are determined for each of the obtained photographs of the cross sections, and the thickness of the antiglare layer for each cross section is calculated based on the median value between the minimum height and the maximum height. The thickness of the antiglare layer of the antiglare layer-attached transparent substrate according to the present embodiment can be obtained by calculating the average value of the thicknesses of the antiglare layer on the cross section at the five locations.

### <Anti-Reflective Layer>

The anti-reflective layer in the present embodiment is a layer that can provide an effect of reducing a reflectance, can reduce dazzle caused by glare from a light, and in the case where the antiglare layer-attached transparent substrate is used in an image display device, can increase a transmittance of a light from the image display device and improve visibility of the image display device.

The anti-reflective layer in the present embodiment preferably has a laminated structure in which at least two dielectric layers having different refractive indices are laminated, and preferably has a function of preventing light reflection.

Therefore, in the antiglare layer-attached transparent substrate 100 shown in FIG. 1, the anti-reflective layer 120 is shown as a single layer, but in practice it is preferably a laminated structure in which two layers, for example, a first dielectric layer and a second dielectric layer having different refractive indices, are laminated. When the first dielectric layer and the second dielectric layer having different refractive indices are laminated, the light reflection can be prevented. The first dielectric layer is a high refractive index layer and the second dielectric layer is a low refractive index layer.

The anti-reflective layer in the present embodiment may or may not have a light absorption ability.

Here, the anti-reflective layer “having a light absorption ability” means that the anti-reflective layer has a luminous transmittance of 90% or less. The luminous transmittance can be measured according to the provisions in JIS Z 8709 (1999).

In the case where the anti-reflective layer does not have a light absorption ability, the first dielectric layer and the second dielectric layer are preferably each mainly formed of an oxide containing at least one element selected from the group consisting of Si, Nb, Ti, Zr, Ta, Al, Sn, and In, or a nitride containing at least one element selected from the group consisting of Si and Al. Among them, it is preferable that the first dielectric layer be formed of Nb₂O₅ or TiO₂ and the second dielectric layer be formed of SiO₂.

Here, “mainly” means a component that has the largest content (in terms of mass) in the first dielectric layer and the second dielectric layer, and means that, for example, 70 mass % or more of the component is contained.

The constituent materials of the first dielectric layer and the second dielectric layer are appropriately selected from the above oxides or nitrides so as to be desired refractive index layers (a high refractive index layer or a low refractive index layer).

Note that, the first dielectric layer and the second dielectric layer may be formed of only one kind of the above oxides or nitrides, or may be formed of two or more kinds thereof.

In the anti-reflective layer having the above configuration, the first dielectric layer preferably has an extinction coefficient of 0.01 or less.

In addition, in the case where the anti-reflective layer has a light absorption ability, the first dielectric layer (high refractive index layer) is preferably mainly formed of a mixed oxide of an oxide containing at least one element selected from the group A consisting of Mo and W and an oxide containing at least one element selected from the group B consisting of Si, Nb, Ti, Zr, Ta, Al, Sn, and In. Among them, Mo in the group A is preferred, and Nb in the group B is preferred.

In the mixed oxide, a content of elements of the group B contained in the mixed oxide (hereinafter, referred to as a group B content) is preferably 65 mass % or less with respect to a total of elements of the group A contained in the mixed oxide and the elements of the group B contained in the mixed oxide.

When the group B content in the first dielectric layer (A-B—O), which is formed of the mixed oxide of an oxide containing at least one element selected from the group A consisting of Mo and W and an oxide containing at least one element selected from the group B consisting of Si, Nb, Ti, Zr, Ta, Al, Sn, and In, is 65 mass % or less, it is possible to prevent a transmitted light from being yellowish.

In the case where the anti-reflective layer has a light absorption ability, the second dielectric layer is preferably mainly formed of a Si oxide (SiOₓ). Here, x<2.

Generally, an oxygen-deficient silicon oxide layer is yellowish under a visible light. However, for example, a first dielectric layer formed of a mixed oxide of an oxide containing Mo as the group A and an oxide containing Nb as the group B is more preferably used together with a second dielectric layer which is an oxygen-deficient silicon oxide layer, since the silicon oxide layer is not yellowish even when there is oxygen deficiency.

In the present embodiment, since the anti-reflective layer having a light absorption ability is disposed at a position closer to a surface into which an external light enters in an image display device, the light reflected by the anti-reflective layer and the transparent substrate can be absorbed efficiently. Accordingly, a display contrast is increased, and the visibility is excellent.

Note that, as a light transmitting film having a light absorption ability and an insulating property, a halftone mask for use in the semiconductor production field is known. As the halftone mask, an oxygen-deficient film such as a Mo—SiOₓ film containing a small amount of Mo is used. In addition, as the light transmitting film having a light absorption ability and an insulating property, a narrow bandgap film for use in the semiconductor production field is known.

However, these light transmitting films have a high light absorption ability on the short wavelength side of the visible light, so that the transmitted light is yellowish. Therefore, they are not suitable for application to an image display device.

In the present embodiment, in the case where the first dielectric layer has a high content of Mo or W and the second dielectric layer is formed of SiOₓ or the like, it is possible to obtain an antiglare layer-attached transparent substrate having a light absorption ability, an insulating property, and excellent adhesion and strength.

In the case of the above configuration having a light absorption ability, the first dielectric layer has an extinction coefficient of preferably 0.005 to 3, and more preferably 0.04 to 0.38. When the extinction coefficient is 0.005 or more, a desired absorption rate can be achieved with an appropriate number of layers. In addition, when the extinction coefficient is 3 or less, it is relatively easy to achieve both a reflection color tone and a transmittance.

In the present embodiment, the first dielectric layer preferably has a refractive index at a wavelength of 550 nm of 1.8 to 2.3 from the viewpoint of a transmittance with the transparent substrate.

The structure of the anti-reflective layer may be a laminated structure of a total of two layers, in which the first dielectric layer and the second dielectric layer are laminated, or a laminated structure in which three or more dielectric layers having different refractive indices are laminated.

In this case, it is not necessary for all dielectric layers to have different refractive indices. For example, in the case of a three-layer laminated structure, it can be a three-layer laminated structure including a low refractive index layer, a high refractive index layer, and a low refractive index layer, or a three-layer laminated structure including a high refractive index layer, a low refractive index layer, and a high refractive index layer. In the former case, the two low refractive index layers may have the same refractive index, and in the latter case, the two high refractive index layers may have the same refractive index. In the case of a four-layer laminated structure, it can be a four-layer laminated structure including a low refractive index layer, a high refractive index layer, a low refractive index layer, and a high refractive index layer, or a four-layer laminated structure including a high refractive index layer, a low refractive index layer, a high refractive index layer, and a low refractive index layer. In this case, the two low refractive index layers or the two high refractive index layers may independently have the same refractive index.

In the case of a laminated structure in which three or more layers having different refractive indices are laminated, a dielectric layer other than the first dielectric layer and the second dielectric layer may be included. In this case, each layer is selected to form a three-layer laminated structure including a low refractive index layer, a high refractive index layer, and a low refractive index layer, or a three-layer laminated structure including a high refractive index layer, a low refractive index layer, and a high refractive index layer, or a four-layer laminated structure including a low refractive index layer, a high refractive index layer, a low refractive index layer, and a high refractive index layer, or a four-layer laminated structure including a high refractive index layer, a low refractive index layer, a high refractive index layer, and a low refractive index layer, each laminated structure including the first dielectric layer and the second dielectric layer.

The outermost layer is preferably the second dielectric layer. When the outermost layer is the second dielectric layer in order to obtain low reflectivity, production is relatively easy. In addition, in the case of forming an antifouling film to be described later on the anti-reflective layer 120, it is preferable to form the antifouling film on the second dielectric layer from the viewpoint of bonding properties related to the durability of the antifouling film.

The first dielectric layer is preferably amorphous. Being amorphous, it can be prepared at a relatively low temperature, and is suitable for use in the case where the transparent substrate includes a resin, since the resin is not damaged by heat.

For example, the thickness of the anti-reflective layer is preferably in a range of 100 nm to 500 nm, and more preferably in a range of 200 nm to 300 nm.

### <Antifouling Film>

The antiglare layer-attached transparent substrate according to the present embodiment may further include an antifouling film (also referred to as an “anti finger print (AFP) film”) on the anti-reflective layer, from the viewpoint of protecting the outermost surface of the anti-reflective layer. The antifouling film can be formed of, for example, a fluorine-containing organosilicon compound. The fluorine-containing organosilicon compound is not particularly limited as long as it can impart an antifouling property, water repellency, and oil repellency, and examples thereof include a fluorine-containing organosilicon compound having one or more groups selected from the group consisting of a polyfluoropolyether group, a polyfluoroalkylene group, and a polyfluoroalkyl group. Note that, the polyfluoropolyether group is a divalent group having a structure in which polyfluoroalkylene groups and etheric oxygen atoms are alternately bonded.

As a commercially available fluorine-containing organosilicon compound having one or more groups selected from the group consisting of a polyfluoropolyether group, a polyfluoroalkylene group, and a polyfluoroalkyl group, KP-801 (trade name, manufactured by Shin-Etsu Chemical Co., Ltd.), KY178 (trade name, manufactured by Shin-Etsu Chemical Co., Ltd.), KY-130 (trade name, manufactured by Shin-Etsu Chemical Co., Ltd.), KY-185 (trade name, manufactured by Shin-Etsu Chemical Co., Ltd.), and Optool (registered trademark) DSX and Optool AES (trade name, all manufactured by Daikin Industries, Ltd.) can be preferably used.

In the case where the antiglare layer-attached transparent substrate according to the present embodiment includes an antifouling film, the antifouling film is provided on the anti-reflective layer. In the case where the anti-reflective layer is provided on both main surfaces of the transparent substrate, the antifouling film can be formed on both the anti-reflective layers, or the antifouling film may be laminated on only one of the main surfaces. This is because the antifouling film only needs to be provided at places where there is a possibility of contact with human hands, and the configuration can be selected according to the application.

### <Properties>

### (Haze Value)

The antiglare layer-attached transparent substrate according to the present embodiment has a haze value of 30% or more. When the haze value is 30% or more, the glare from the external light can be more effectively prevented. The haze value is more preferably 35% or more, still more preferably 40% or more, and particularly preferably 45% or more. In addition, the haze value is preferably 90% or less, more preferably 80% or less, still more preferably 70% or less, and particularly preferably 65% or less, from the viewpoint of image clarity. The haze value is preferably 30% or more and 90% or less, for example.

The haze value is measured according to JIS K 7136:2000 using a haze meter (HR-100 model, manufactured by MURAKAMI COLOR RESEARCH LABORATORY CO., LTD.) or the like.

### (Skewness Ssk)

In the antiglare layer-attached transparent substrate according to the present embodiment, a skewness Ssk on a surface having the antiglare layer is 0.4 or less.

The “skewness Ssk” indicates symmetry of a height distribution defined in ISO25178.

When the value of Ssk is positive, the irregular shape is distributed biased toward a higher side, and a convex portion is sharp. On the other hand, when the value of Ssk is negative, the irregular shape is distributed biased toward a lower side, and the convex portion tends to be gentle. In the case where the Ssk on the surface having the antiglare layer is 0.4 or less in the antiglare layer-attached transparent substrate according to the present embodiment, the fibers of the cloth do not get caught in the fine irregular shape on the surface and the cloudiness is prevented when the surface of the antiglare layer-attached transparent substrate is wiped with a cloth. The Ssk is preferably 0.3 or less, more preferably 0.2 or less, and still more preferably 0.1 or less. In addition, the Ssk is preferably 0 or more from the viewpoint of the antifouling property. Here, the “antifouling property” means that stains that have entered recessed portions of the irregular shape on the surface of the antiglare layer-attached transparent substrate are difficult to remove from the recessed portion.

### (Dynamic Friction Coefficient)

In the antiglare layer-attached transparent substrate according to the present embodiment, a dynamic friction coefficient determined by the following method is preferably 0.3 or less. When the dynamic friction coefficient is 0.3 or less, the cloudiness of the surface is prevented when the surface is wiped with a cloth. This is because when the surface of the antiglare layer-attached transparent substrate is wiped with a cloth, the cloth does not get caught on the irregular shape formed on the surface. The dynamic friction coefficient is preferably 0.28 or less, more preferably 0.25 or less, still more preferably 0.22 or less, and particularly preferably 0.2 or less. The dynamic friction coefficient is generally 0.05 or more, and preferably 0.1 or more. The dynamic friction coefficient is preferably 0.05 or more and 0.3 or less, for example.

Method: The measurement is performed by moving a cloth (for example, cleanroom wiping cloth Techno Wiper LT100, manufactured by Tecnos Inc.), in one direction and under a load of 500 g, a contact area of 1 cm×1 cm, and a speed of 500 mm/min, on the surface of the antiglare layer-attached transparent substrate having the antiglare layer.

### (Static Friction Coefficient)

In the antiglare layer-attached transparent substrate according to the present embodiment, a static friction coefficient determined by the following method is preferably 0.21 or less. When the static friction coefficient is 0.21 or less, the cloudiness is prevented when the surface is wiped with a cloth. The static friction coefficient is more preferably 0.20 or less. The static friction coefficient is generally 0.05 or more, and preferably 0.1 or more. The static friction coefficient is preferably 0.05 or more and 0.21 or less, for example.

Method: An initial value is measured at the start of moving a cloth (for example, cleanroom wiping cloth Techno Wiper LT100, manufactured by Tecnos Inc.), in one direction and under a load of 500 g, a contact area of 1 cm×1 cm, and a speed of 500 mm/min, on the surface having the antiglare layer.

The reason why the dynamic friction coefficient is larger than the static friction coefficient in the antiglare layer-attached transparent substrate according to the present embodiment is thought to be that the cloth is destroyed during friction, and the remains remain on the surface.

In addition, in the antiglare layer-attached transparent substrate according to the present embodiment, a difference between the dynamic friction coefficient and the static friction coefficient (dynamic friction coefficient-static friction coefficient) is preferably 0.05 or less. When the difference between the dynamic friction coefficient and the static friction coefficient is 0.05 or less, the cloudiness of the surface is prevented when the surface is wiped with a cloth. The difference between the dynamic friction coefficient and the static friction coefficient is more preferably 0.05 or less, and still more preferably less than 0, i.e., a negative value.

### (Cloudiness Caused by Cloth)

In the antiglare layer-attached transparent substrate according to the present embodiment, even when the surface is wiped with a cloth, no cloudiness is observed on the surface of the antiglare layer-attached transparent substrate. The “no cloudiness is observed” means, more specifically, that no whitish locations are observed on the surface of the antiglare layer-attached transparent substrate even after the following treatment is performed.

(Treatment) The surface on which the antiglare layer is provided is rubbed 10 times with a cloth (for example, cleanroom wiping cloth Techno Wiper LT100, manufactured by Tecnos Inc.) under a load condition of 100 g/cm². During observation, a black tape (for example, black vinyl tape manufactured by 3M) is attached to the surface of the antiglare layer-attached transparent substrate opposite the side on which the antiglare layer is provided.

### <Production Method>

A method for producing an antiglare layer-attached transparent substrate according to the present invention includes the following steps.
(1) a step of forming an antiglare layer on at least one surface of a transparent substrate
(2) a step of forming an anti-reflective layer on a surface of the antiglare layer Hereinafter, the steps are described.

### (1) Step of Forming Antiglare Layer on at Least One Surface of Transparent Substrate

An antiglare layer is formed on at least one of a main surfaces of a transparent substrate. The transparent substrate is formed of a transparent member such as a glass or a resin as described above, or a plastic, and the antiglare layer includes a resin matrix and fine particles dispersed in the resin matrix.

The method for forming the antiglare layer is not particularly limited. The antiglare layer can be formed, for example, by using a wet method. Examples of the wet method include a method of preparing a slurry containing a matrix resin and fine particles, and spray-coating at least one surface of main surfaces of a transparent substrate with the slurry, and a method of coating the slurry manually or by using a coater. In the case where the matrix resin is an ultraviolet-curable resin or a thermosetting resin, the provided slurry can be cured by ultraviolet irradiation or heating to form an antiglare layer.

The viscosity of the slurry may be adjusted by adding a solvent. Preferred examples of the solvent include lower alcohols such as methyl alcohol, ethyl alcohol, and isopropyl alcohol, methyl cellosolve, ethyl cellosolve, butyl cellosolve, polyethylene glycol methyl ether, polyethylene glycol methyl ether acetate, dimethylformamide, N,N′-dimethylacetamide, N-methyl-2-pyrrolidone, tetrahydrofuran, dioxane, and toluene.

In addition, in order to improve the adhesion between the antiglare layer and the anti-reflective layer, the antiglare layer may be subjected to a surface treatment. Examples of the surface treatment include a corona treatment, a UV/ozone treatment, and an ion beam treatment.

### (2) Step of Forming Anti-Reflective Layer on Surface of Antiglare Layer

Next, an anti-reflective layer is formed on a surface of the antiglare layer. The method for forming the anti-reflective layer is not particularly limited, and the anti-reflective layer may be formed by using a dry method or a wet method. Examples of the dry method include a vapor deposition method, a sputtering method, a physical vapor deposition (PVD) method, or a chemical vapor deposition (CVD) method. Examples of the wet method include a labia method and a die method. Among them, the dry method is preferred from the viewpoint of surface hardness.

Examples of the sputtering method include methods such as magnetron sputtering, pulse sputtering. AC sputtering, and digital sputtering.

For example, the magnetron sputtering method is a method in which a magnet is placed on a back surface of a base dielectric material to generate a magnetic field, and gas ion atoms collide with the surface of the dielectric material and are ejected, to form a sputtering film having a thickness of several nm, and a continuous film of a dielectric that is an oxide or a nitride of the dielectric material can be formed.

In addition, for example, the digital sputtering method is a method of forming a metal oxide thin film by repeating steps of first forming a metal ultra-thin film by sputtering, and then oxidizing the film by irradiation with oxygen plasma, oxygen ions, or oxygen radicals in the same chamber, unlike a general magnetron sputtering method. In this case, since film-forming molecules are metals when deposited on a substrate, it is presumed to be more ductile than a case of depositing a metal oxide. Therefore, it is thought that even when the energy is the same, rearrangement of the film-forming molecules is likely to occur, and as a result, a dense and smooth film can be formed.

Further, an antifouling film may be formed on the above anti-reflective layer. The antifouling film can be formed, for example, by using a vapor deposition method.

### <Application>

The antiglare layer-attached transparent substrate according to the present embodiment is suitable as a cover glass of an image display device, particularly a cover glass of an image display device mounted on a vehicle such as an image display device for a navigation system mounted on a vehicle. Note that, as the image display device for a navigation system mounted on a vehicle, a liquid crystal display (LCD) having heat resistance and durability is used.

### (Image Display Device)

An image display device according to one embodiment of the present invention includes the above antiglare layer-attached transparent substrate. Examples of the image display device include an embodiment including the above antiglare layer-attached transparent substrate on a liquid crystal display (LCD).

### EXAMPLES

Hereinafter, the present invention is described in detail with reference to Examples, but the present invention is not limited thereto.

Hereinafter, Example 1 to Example 6, Example 17, and Example 18 are Inventive Examples, and Example 7 to Example 16 are Comparative Examples.

### Example 1

An antiglare layer and an anti-reflective layer were formed in this order on one main surface of a transparent substrate by the following method, to prepare an antiglare layer-attached transparent substrate.

As the transparent substrate, a PET film having a thickness of 100 μm (COSMOSHINE A4360, manufactured by TOYOBO CO., LTD.) was used. The transparent substrate has a visible light transmittance of 92%.

An antiglare layer was formed on one surface (first surface) of this transparent substrate by the following method.

First, acrylic (PMMA) resin particles having a spherical shape and an average particle diameter of 5 μm were used as fine particles, and the fine particles and an acrylic resin (hereinafter referred to as a “matting agent”) were mixed in a weight ratio of 80:100 to prepare a mixed liquid. Further, propylene glycol monomethyl ether was added to this mixed liquid to dilute the solid content to 40%.

Next, the obtained coating liquid was applied onto the first surface of the transparent substrate using a bar coater. Next, this transparent substrate was charged into a hot air drying oven at 80° C. and held there for 20 minutes to dry the coating liquid.

Thereafter, the coating liquid was cured using an ultraviolet light exposure machine. Accordingly, the antiglare layer was formed on one main surface of the transparent substrate.

Next, an anti-reflective layer was formed on the surface of the antiglare layer by the following method.

The anti-reflective layer was formed by using a metal mode sputtering method.

A sputtering device includes a rotatable cylindrical drum-shaped holder and an oxidation source disposed around the holder. The oxidation source can form a microwave plasma by electron cyclotron resonance (ECR). When forming the anti-reflective layer, the substrate is placed on the holder, and a metal target is disposed around the holder.

When forming the anti-reflective layer, under a reduced pressure, with the holder rotating at a high speed, an argon gas is supplied to the metal target to which a voltage is applied, and an oxygen gas is supplied to the oxidation source to which a voltage is applied. The argon gas causes metal atoms to be ejected from the metal target, which are then deposited on the substrate. Since the substrate is rotated by the holder, the metal atoms formed on the substrate are instantly oxidized by oxygen plasma supplied from the oxidation source when the metal atoms face the oxidation source.

In the sputtering device used, this operation is repeated, allowing an oxide thin film of the target metal to be deposited on the substrate.

In Example 1, the anti-reflective layer has a four-layer structure consisting of a first layer to a fourth layer, in the order of titanium oxide (TiO₂: first layer), silicon oxide (SiO₂: second layer), titanium oxide (TiO₂: third layer), and silicon oxide (SiO₂: fourth layer) from the side closest to the substrate.

First, the first layer was formed under the following conditions.

Target: metal titanium

Amount of argon gas supply to target: 3000 sccm

Power supplied to target: 10 KW

Amount of oxygen gas supplied to oxidation source: 400 sccm

Power supplied to oxidation source: 1050 KW.

Next, the second layer was formed under the following conditions.

Target: metal silicon

Amount of argon gas supply to target: 3000 sccm

Power supplied to target: 10 KW

Amount of oxygen gas supplied to oxidation source: 750 sccm

Power supplied to oxidation source: 1050 KW.

Next, the third layer was formed. The film-forming conditions were the same as those for the first layer.

Next, the fourth layer was formed. The film-forming conditions were the same as those for the second layer.

Accordingly, a low reflection layer was formed, which was composed of a first layer having a thickness of 12 nm, a second layer having a thickness of 33 nm, a third layer having a thickness of 111 nm, and a fourth layer having a thickness of 92 nm.

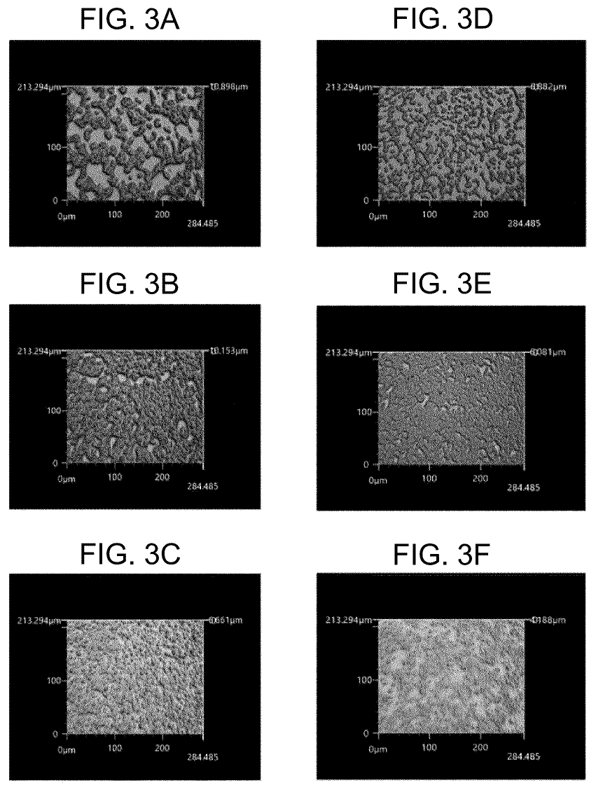

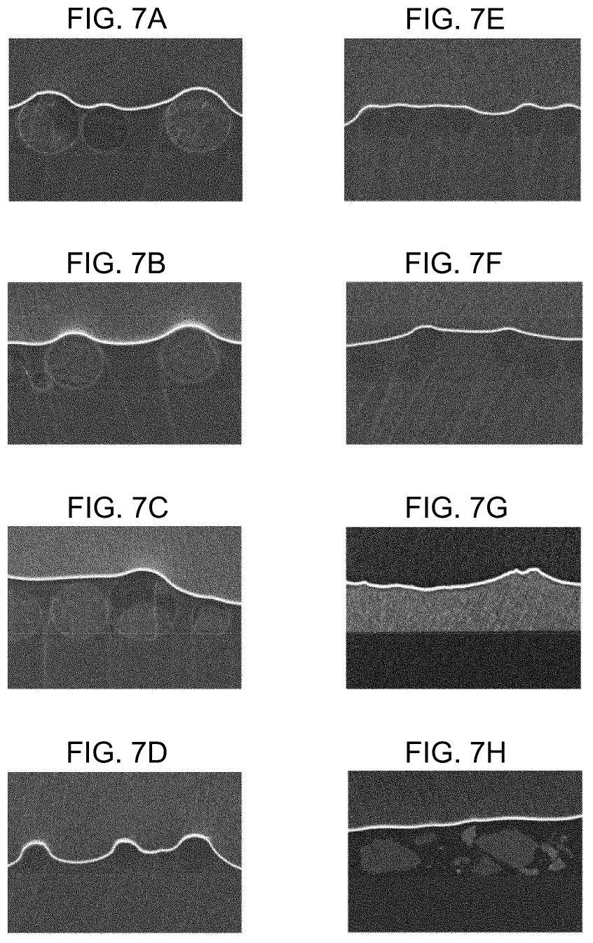

By the above method, an antiglare layer-attached transparent substrate was prepared. Note that, FIG. 3A shows a photograph of a surface shape of the antiglare layer-attached transparent substrate obtained above taken with a laser microscope VK-X3000 manufactured by Keyence Corporation. In addition, a cross section of the antiglare layer-attached transparent substrate was observed with a scanning electron microscope (SEM). FIG. 7A shows an SEM image of a cross section of the antiglare layer portion.

### Examples 2 and 3

Antiglare layer-attached transparent substrates were prepared in the same manner as in Example 1, except that the thickness of the antiglare layer was changed to the value shown in Table 1. FIGS. 3B and 3C respectively show laser microscope photographs of surface shapes of the obtained antiglare layer-attached transparent substrates, and FIGS. 7B and 7C respectively show SEM images of cross sections of the antiglare layers.

### Example 4

An antiglare layer-attached transparent substrate was prepared in the same manner as in Example 1, except that in forming the antiglare layer, the fine particles were polystyrene (PS) resin particles having a spherical shape and an average particle diameter of 3 μm, the fine particles and the matting agent were mixed in a weight ratio of 70:100, and the thickness of the antiglare layer was changed to the value shown in Table 1. FIG. 3D shows a laser microscope photograph of a surface shape of the obtained antiglare layer-attached transparent substrate, and FIG. 7D shows an SEM image of a cross section of the antiglare layer.

### Examples 5 and 6

Antiglare layer-attached transparent substrates were prepared in the same manner as in Example 4, except that the thickness of the antiglare layer was changed to the value shown in Table 1. FIGS. 3E and 3F respectively show laser microscope photographs of surface shapes of the obtained antiglare layer-attached transparent substrates, and FIGS. 7E and 7F respectively show SEM images of cross sections of the antiglare layers.

### Example 7

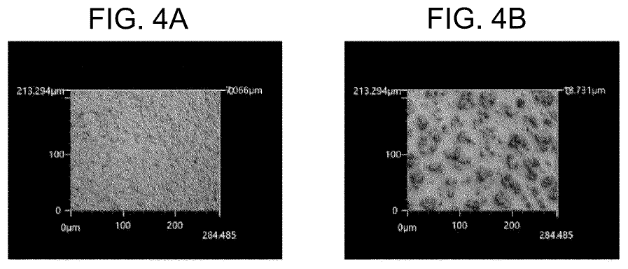

An antiglare layer-attached transparent substrate was prepared in the same manner as in Example 1, except that in forming the antiglare layer, the fine particles were silica particles having a non-spherical shape and an average particle diameter of 2 μm, the fine particles and the matting agent were mixed in a weight ratio of 70:100, and the thickness of the antiglare layer was changed to the value shown in Table 1. FIG. 4A shows a laser microscope photograph of a surface shape of the obtained antiglare layer-attached transparent substrate, and FIG. 7G shows an SEM image of a cross section of the antiglare layer.

### Example 8

An antiglare layer-attached transparent substrate was prepared in the same manner as in Example 1, except that in forming the antiglare layer, the fine particles were silica particles having a non-spherical shape and an average particle diameter of 10 μm, the fine particles and the matting agent were mixed in a weight ratio of 40:100, and the thickness of the antiglare layer was changed to the value shown in Table 1. FIG. 4D shows a laser microscope photograph of a surface shape of the obtained antiglare layer-attached transparent substrate, and FIG. 7H shows an SEM image of a cross section of the antiglare layer.

### Example 9

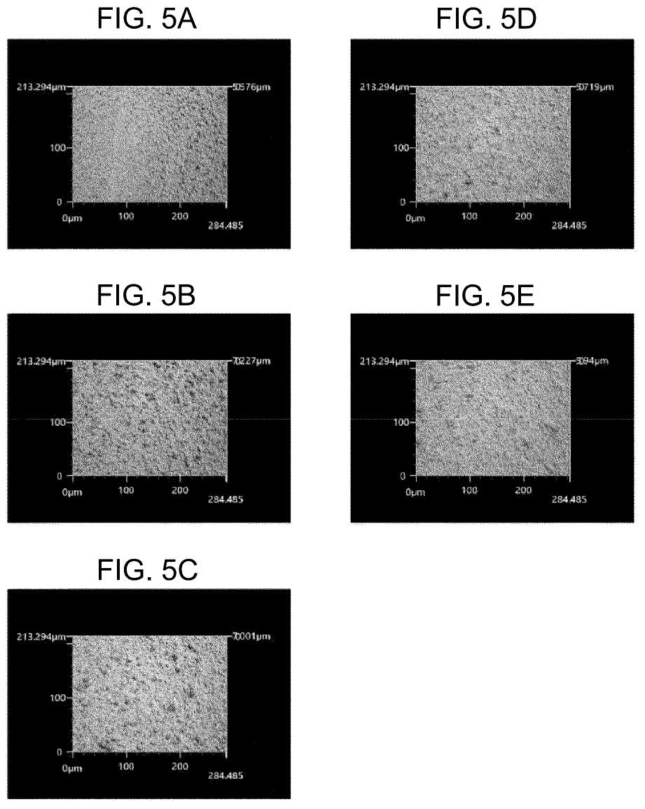

An antiglare layer-attached transparent substrate was prepared in the same manner as in Example 1, except that in forming the antiglare layer, the fine particles were silica particles having a non-spherical shape and an average particle diameter of 4 μm, and were mixed with the matting agent in a weight ratio of 80:100, and the thickness of the antiglare layer was changed to the value shown in Table 1. FIG. 5A shows a laser microscope photograph of a surface shape of the obtained antiglare layer-attached transparent substrate.

### Examples 10 to 13

Antiglare layer-attached transparent substrates were prepared in the same manner as in Example 9, except that the thickness of the antiglare layer was changed to the value shown in Table 1. FIGS. 5B to 5E respectively show laser microscope photographs of surface shapes of the obtained antiglare layer-attached transparent substrates.

### Example 14

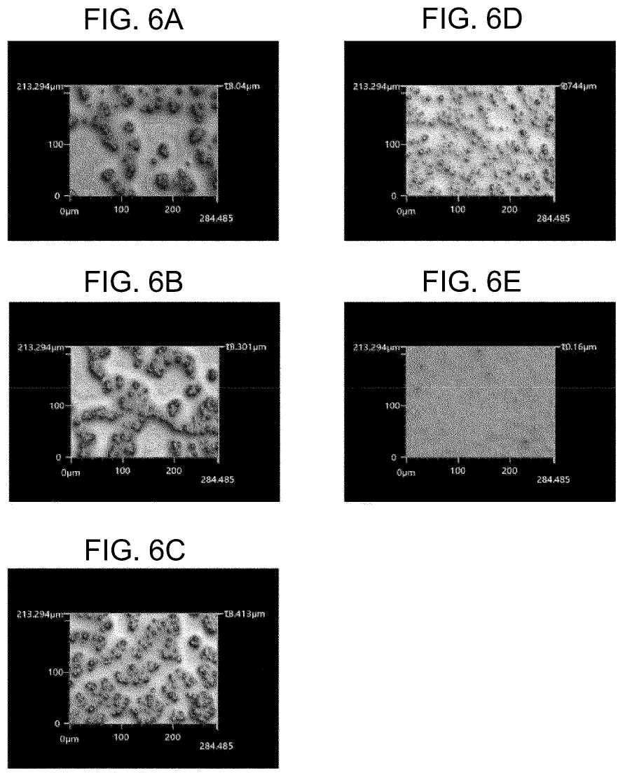

An antiglare layer-attached transparent substrate was prepared in the same manner as in Example 1, except that in forming the antiglare layer, the fine particles were acrylic (PMMA) resin particles having a spherical shape and an average particle diameter of 10 μm, the fine particles and the matting agent were mixed in a weight ratio of 40:100, and the thickness of the antiglare layer was changed to the value shown in Table 1. FIG. 6A shows a laser microscope photograph of a surface shape of the obtained antiglare layer-attached transparent substrate.

### Examples 15 to 18

Antiglare layer-attached transparent substrates were prepared in the same manner as in Example 14, except that the thickness of the antiglare layer was changed to the value shown in Table 1. FIGS. 6B to 6E respectively show laser microscope photographs of surface shapes of the obtained antiglare layer-attached transparent substrates.

Each of the antiglare layer-attached transparent substrates obtained above was evaluated as follows. The results are shown in Table 1. Note that, in Table 1, “-” means not measured.

### (Average Particle Diameter of Fine Particles)

The surface image of the antiglare layer-attached transparent substrate was taken with an optical microscope (ECLIPSE L300N manufactured by Nikon). A maximum diameter of each of 12 fine particles freely selected from the obtained surface image in any 120 μm×100 μm region was measured, and the average particle diameter was calculated by averaging the maximum diameters. In the case where the fine particles were non-spherical, the maximum major diameter was used as the particle diameter to calculate the average particle diameter.

Note that, the average particle diameter of the fine particles before being mixed with the matrix and the average particle diameter obtained by the above measurement were substantially the same. “Substantially the same” means that the ratio of the average particle diameter obtained by the above measurement to the average particle diameter of the fine particles before being mixed into the matrix is 0.9 to 1.1.

In addition, in Examples 1 to 13, the “maximum value” and the “minimum value” in the table refer to the values of the largest and smallest maximum diameters, respectively, in the above measurement.

### (Thickness of Antiglare Layer)

Photographs of cross-sections of the antiglare layer-attached transparent substrate at any five locations, each having 15 μm×20 μm, were taken with a scanning electron microscope (Regulus 8220, manufactured by Hitachi High-Technologies Corporation). Next, the maximum height and the minimum height were determined for each of the obtained photographs of the cross sections, and the thickness of the antiglare layer for each cross section was calculated based on the median value between the maximum height and minimum height. The average value of the thicknesses of the antiglare layer on the cross sections at five locations was calculated, and the obtained value was the thickness of the antiglare layer of the antiglare layer-attached transparent substrate.

### (Haze Value)

The haze value was measured according to JIS K 7136:2000 using a haze meter (HR-100 model, manufactured by MURAKAMI COLOR RESEARCH LABORATORY CO., LTD.).

### (Skewness Ssk)

The Skewness Ssk was measured according to ISO25178 using a laser microscope (VK-X3000, manufactured by Keyence Corporation).

### (Cloudiness)

For each of the antiglare layer-attached transparent substrates obtained above, the surface on which the antiglare layer was provided was rubbed 10 times with a cloth (cleanroom wiping cloth Techno Wiper LT100, manufactured by Tecnos Inc.) under the condition of 100 g/cm², and the surface was visually evaluated based on the following evaluation criteria. Note that, during observation, a black tape (black vinyl tape manufactured by 3M) was attached to the surface of the antiglare layer-attached transparent substrate opposite the side on which the antiglare layer was provided.
A: No whitish locations were observed across the entire surface.
B: A whitish location was observed on the entire or part of the surface.

### (Dynamic Friction Coefficient)

A cloth (cleanroom wiping cloth Techno Wiper LT100, manufactured by Tecnos Inc.) was moved, in one direction and under a load of 500 g, a contact area of 1 cm×1 cm, and a speed of 500 mm/min, on the surface having the antiglare layer of each of the antiglare layer-attached transparent substrates obtained above, and the dynamic friction coefficient was measured using a linear sliding tester (HEIDON Tribo Gear 38, manufactured by Shinto Chemical Industry Co., Ltd.).

### (Static Friction Coefficient)

A cloth (cleanroom wiping cloth Techno Wiper LT100, manufactured by Tecnos Inc.) was moved, in one direction and under a load of 500 g, a contact area of 1 cm×1 cm, and a speed of 500 mm/min, on the surface having the antiglare layer of each of the antiglare layer-attached transparent substrates obtained above, and the static friction coefficient was measured as an initial value at the start of this movement using a linear sliding tester (HEIDON Tribo Gear 38, manufactured by Shinto Chemical Industry Co., Ltd.).

TABLE 1

| | | | | | | | | Ratio of (average |
|---|---|---|---|---|---|---|---|---|
| | | | | | | | Average particle | particle diameter of |
| | | | | | | | diameter of fine | fine particles - |
| | Fine particles | | | | | Thickness | particles - | thickness of AG |
| | Average | | | | | of AG | thickness of AG | layer) to thickness |
| | particle | Minimum | Maximum | | | layer | layer | of AG layer |
| | diameter | value | value | Material | Shape | [μm] | [μm] | [%] |
| Example | 5 | 3.1 | 7 | PMMA | Spherical | 2 | 3 | 150 |
| 1 | | | | resin | | | | |
| Example | 5 | 3.6 | 8.3 | PMMA | Spherical | 3 | 2 | 67 |
| 2 | | | | resin | | | | |
| Example | 5 | 3.7 | 7.8 | PMMA | Spherical | 4 | 1 | 25 |
| 3 | | | | resin | | | | |
| Example | 3 | 2.3 | 4.9 | PS resin | Spherical | 1 | 2 | 200 |
| 4 | | | | | | | | |
| Example | 3 | 1.8 | 5.2 | PS resin | Spherical | 2 | 1 | 50 |
| 5 | | | | | | | | |
| Example | 3 | 1.7 | 6.2 | PS resin | Spherical | 3 | 0 | 0 |
| 6 | | | | | | | | |
| Example | 2 | 1.7 | 6.1 | Silica | Non- | 2.5 | −0.5 | −20 |
| 7 | | | | | spherical | | | |
| Example | 10 | 5.5 | 13.5 | Silica | Non- | 5 | 5 | 100 |
| 8 | | | | | spherical | | | |
| Example | 4 | 3 | 5 | Silica | Non- | 1.4 | 2.6 | 186 |
| 9 | | | | | spherical | | | |
| Example | 4 | 3 | 5 | Silica | Non- | 2 | 2 | 100 |
| 10 | | | | | spherical | | | |
| Example | 4 | 3 | 5 | Silica | Non- | 4 | 0 | 0 |
| 11 | | | | | spherical | | | |
| Example | 4 | 3 | 5 | Silica | Non- | 6 | −2 | −33 |
| 12 | | | | | spherical | | | |
| Example | 4 | 3 | 5 | Silica | Non- | 8 | −4 | −50 |
| 13 | | | | | spherical | | | |
| Example | 10 | — | — | PMMA | Spherical | 1.3 | 8.7 | 669 |
| 14 | | | | resin | | | | |
| Example | 10 | — | — | PMMA | Spherical | 3 | 7 | 233 |
| 15 | | | | resin | | | | |
| Example | 10 | — | — | PMMA | Spherical | 5 | 5 | 100 |
| 16 | | | | resin | | | | |
| Example | 10 | — | — | PMMA | Spherical | 7 | 3 | 43 |
| 17 | | | | resin | | | | |
| Example | 10 | — | — | PMMA | Spherical | 10 | 0 | 0 |
| 18 | | | | resin | | | | |

Friction coefficient

| | Haze | Skewness | Static friction | Dynamic friction | |
|---|---|---|---|---|---|
| | [%] | Ssk | coefficient | coefficient | Cloudiness |
| Example | 74 | 0.17 | — | — | A |
| 1 | | | | | |
| Example | 82 | 0.11 | — | — | A |
| 2 | | | | | |
| Example | 73 | 0.15 | 0.202 | 0.182 | A |
| 3 | | | | | |
| Example | 66 | 0.08 | — | — | A |
| 4 | | | | | |
| Example | 85 | 0.09 | — | — | A |
| 5 | | | | | |
| Example | 67 | 0.16 | 0.209 | 0.207 | A |
| 6 | | | | | |
| Example | 60 | 1.25 | 0.218 | 0.355 | B |
| 7 | | | | | |
| Example | 60 | 0.65 | 0.21 | 0.369 | B |
| 8 | | | | | |
| Example | 76 | 1.56 | — | — | B |
| 9 | | | | | |
| Example | 76 | 1.34 | — | — | B |
| 10 | | | | | |
| Example | 72 | 0.9 | — | — | B |
| 11 | | | | | |
| Example | 68 | 0.72 | — | — | B |
| 12 | | | | | |
| Example | 65 | 0.57 | — | — | B |
| 13 | | | | | |
| Example | 66 | 0.38 | — | — | B |
| 14 | | | | | |
| Example | 72 | 0.25 | — | — | B |
| 15 | | | | | |
| Example | 71 | 0.39 | — | — | B |
| 16 | | | | | |
| Example | 45 | 0.16 | — | — | A |
| 17 | | | | | |
| Example | 45 | 0.05 | — | — | A |
| 18 | | | | | |

As seen from Table 1, in the antiglare layer-attached transparent substrates in Example 1 to Example 6, Example 17, and Example 18 as Inventive Examples, the haze value was 30% or more, and no cloudy locations were observed on the surface of the antiglare layer-attached transparent substrate when the surface was wiped with a cloth.

On the other hand, in the antiglare layer-attached transparent substrates in Example 7 to Example 16 as Comparative Examples, some locations of the surface had cloudiness when the surface was wiped with a cloth.

Although various embodiments have been described above with reference to the drawings, it is needless to say that the present invention is not limited to such examples. It is obvious for a person skilled in the art that various modifications and variations can be made within the category described in the scope of claims and it is understood that such modifications and variations naturally belong to the technical scope of the present invention. Further, the components described in the above embodiment may be combined in any manner without departing from the spirit of the invention.

Note that, the present application is based on a Japanese Patent Application (No. 2022-089066) filed on May 31, 2022, contents of which are incorporated herein by reference.

### REFERENCE SIGNS LIST

100 antiglare layer-attached transparent substrate
110 transparent substrate
120 anti-reflective layer
130 antiglare layer
132 matrix
134 fine particles

1. An antiglare layer-attached transparent substrate comprising:
a transparent substrate comprising two main surfaces; and
an antiglare layer and an anti-reflective layer in this order on at least one main surface of the transparent substrate,
wherein the antiglare layer-attached transparent substrate has a haze value of 30% or more, and a skewness Ssk of 0.4 or less on a surface having the antiglare layer, and
the antiglare layer comprises fine particles, and a difference between a thickness of the antiglare layer and an average particle diameter of the fine particles is 4 μm or less.

2. The antiglare layer-attached transparent substrate according to claim 1, wherein a dynamic friction coefficient on the surface having the antiglare layer is 0.3 or less.

3. The antiglare layer-attached transparent substrate according to claim 1, wherein the fine particles are spherical.

4. The antiglare layer-attached transparent substrate according to claim 1, wherein the fine particles comprise resin particles.

5. The antiglare layer-attached transparent substrate according to claim 1, wherein the fine particles comprise silica particles.

6. The antiglare layer-attached transparent substrate according to claim 1, wherein the anti-reflective layer has a laminated structure in which at least two dielectric layers having different refractive indices are laminated.

7. The antiglare layer-attached transparent substrate according to claim 6, wherein at least one layer of the dielectric layers is mainly formed of an oxide containing at least one element selected from the group consisting of Si, Nb, Ti, Zr, Ta, Al, Sn, and In, or a nitride containing at least one element selected from the group consisting of Si and Al.

8. The antiglare layer-attached transparent substrate according to claim 6, wherein at least one layer of the dielectric layers is mainly formed of a Si oxide,
at least another layer among the layers in the laminated structure is mainly formed of a mixed oxide of an oxide containing at least one element selected from the group A consisting of Mo and W and an oxide containing at least one element selected from the group B consisting of Si, Nb, Ti, Zr, Ta, Al, Sn, and In, and
a content of elements of the group B contained in the mixed oxide is 65 mass % or less with respect to a total of elements of the group A contained in the mixed oxide and the elements of the group B contained in the mixed oxide.

9. The antiglare layer-attached transparent substrate according to claim 1, further comprising an antifouling film on the anti-reflective layer.

10. The antiglare layer-attached transparent substrate according to claim 1, wherein the transparent substrate comprises a glass.

11. The antiglare layer-attached transparent substrate according to claim 1, wherein the transparent substrate comprises a resin.

12. A method for producing the antiglare layer-attached transparent substrate according to claim 1, the method comprising:
forming an antiglare layer on at least one surface of a transparent substrate; and
forming an anti-reflective layer on a surface of the antiglare layer by using a dry method.

13. A method for producing the antiglare layer-attached transparent substrate according to claim 1, the method comprising:
forming an antiglare layer on at least one surface of a transparent substrate; and
forming an anti-reflective layer on a surface of the antiglare layer by using a wet method.

14. An image display device comprising the antiglare layer-attached transparent substrate according to claim 1.
